(19) United States
(12) Patent Application Publication
(10) Pub. No.: US 2009/0216522 A1
(43) Pub. Date: Aug. 27, 2009

(54) APPARATUS, METHOD, AND COMPUTER PROGRAM PRODUCT FOR DETERMING PARTS-OF-SPEECH IN CHINESE

(75) Inventor: Tatsuya Izuha, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/391,284

(22) Filed: Feb. 24, 2009

(30) Foreign Application Priority Data
Feb. 27, 2008 (JP) 2008-46030

(51) Int. Cl. G06F 17/28

(52) U.S. Cl. 704/4; 704/5

(57) ABSTRACT

A word sequence storage unit correspondingly stores Japanese word sequences and Japanese parts-of-speech of the words in the Japanese word sequences. A part-of-speech correspondence storage unit correspondingly stores Japanese parts-of-speech and Chinese parts-of-speech. A translating unit translates an input Chinese word sequence into a Japanese word sequence. A searching unit searches in the word sequence storage unit for Japanese parts-of-speech respectively corresponding to the words in the translated Japanese word sequence. The determining unit determines that the Chinese parts-of-speech stored in the part-of-speech correspondence storage unit in correspondence with the Japanese parts-of-speech found in the search are the parts-of-speech of the Chinese words translated into the Japanese words of which the parts-of-speech were found in the search.

### CROSS-REFERENCE TO RELATED APPLICATIONS

This application is based upon and claims the benefit of priority from the prior Japanese Patent Application No. 2008-46030, filed on Feb. 27, 2008; the entire contents of which are incorporated herein by reference.

### BACKGROUND OF THE INVENTION

1. Field of the Invention

The present invention relates to an apparatus, a method, and a computer program product for determining the part-of-speech of each of words in a Chinese word sequence.

2. Description of the Related Art During a natural language processing procedure used in, for example, machine translation, it is often necessary to determine the parts-of-speech of the words in an input sentence. To determine the parts-of-speech, it is necessary to assign parts-of-speech to the words stored in a dictionary in advance. JP-A H11-212974 (KOKAI) proposes a technique that, by making use of parts-of-speech in another language, reduces the labor required to assign parts-of-speech to the words in a target language that are stored in a dictionary.

Generally speaking, in many languages such as Japanese, English, and Chinese, a word can have a plurality of parts-of-speech without involving any superficial change. Thus, for such a word that can have a plurality of parts-of-speech, it is necessary to determine which one of the parts-of-speech the word is being used as, in an input sentence.

For example, a Chinese verb meaning “to manage” is expressed with two Chinese characters. On the other hand, the same set of two Chinese Characters can also be used as a noun meaning “management”. Thus, it is necessary to come up with a method for correctly determining which part-of-speech (i.e., a verb or a noun) the set of two Chinese characters is used as, according to the context in the input sentence. As examples of methods for selecting an appropriate part-of-speech from among a plurality of candidates of parts-of-speech, statistical methods like a “Hidden Markov Model” are conventionally known.

However, when such a statistical method is used, a problem remains where it is necessary to acquire a large amount of training data serving as correct-answer examples that are used for obtaining statistical values. Further, to create the training data, it is necessary to manually check all the examples regarding such words that have a plurality of parts-of-speech.

### SUMMARY OF THE INVENTION

According to one aspect of the present invention, a part-of-speech determining apparatus that determines a part-of-speech of each Chinese word, the apparatus includes a word sequence storage unit that correspondingly stores Japanese word sequences each of which is made up of a plurality of words used being joined together, and Japanese parts-of-speech of the words contained in the Japanese word sequences; a part-of-speech correspondence storage unit that correspondingly stores Japanese parts-of-speech and Chinese parts-of-speech; an input unit that receives an input of a Chinese word sequence; a translating unit that generates a translated word sequence by translating the Chinese word sequence into Japanese; a searching unit that conducts a search, while using consecutive Japanese words contained in the translated word sequence as a key word sequence, in the word sequence storage unit for Japanese parts-of-speech corresponding to one of the Japanese word sequences that matches the key word sequence; an obtaining unit that obtains two or more of the Chinese parts-of-speech corresponding to the Japanese parts-of-speech found in the search, from the part-of-speech correspondence storage unit; and a determining unit that determines that the obtained Chinese parts-of-speech are respectively parts-of-speech of Chinese words translated into the Japanese words contained in the key word sequence.

According to another aspect of the present invention, a part-of-speech determining method implemented by a part-of-speech determining apparatus that determines a part-of-speech of each Chinese word, the method includes receiving an input of a Chinese word sequence; generating a translated word sequence by translating the Chinese word sequence into Japanese; conducting a search, while using consecutive Japanese words contained in the translated word sequence as a key word sequence, in a word sequence storage unit for Japanese parts-of-speech that correspond to one of Japanese word sequences that matches the key word sequence, the word sequence storage unit correspondingly storing the Japanese word sequences each of which is made up of a plurality of words that are used while being joined together, and Japanese parts-of-speech of the words contained in the Japanese word sequences; obtaining two or more of the Chinese parts-of-speech that correspond to the Japanese parts-of-speech found in the search, from a part-of-speech correspondence storage unit correspondingly storing Japanese parts-of-speech and Chinese parts-of-speech; and determining that the obtained Chinese parts-of-speech are respectively parts-of-speech of Chinese words that have been translated into the Japanese words contained in the key word sequence.

A computer program product according to still another aspect of the present invention causes a computer to perform the method according to the present invention.

### BRIEF DESCRIPTION OF THE DRAWINGS

FIG. 1 is a block diagram of a term extracting apparatus serving as a part-of-speech determining apparatus according to an embodiment of the present invention;

FIG. 2 is a drawing of an example of a data structure of a parallel translation dictionary;

FIG. 3 is a drawing of another example of a data structure of a parallel translation dictionary;

FIG. 4 is a drawing of an example of a data structure of data stored in a word sequence storage unit;

FIG. 5 is a drawing of an example of a data structure of data stored in a part-of-speech correspondence storage unit;

FIG. 6 is a flowchart of an overall procedure in a term extracting process according to the embodiment of the present invention;

FIG. 7 is a drawing of an example of a processing table;

FIG. 8 is a drawing of another example of the processing table;

FIG. 9 is a drawing of yet another example of the processing table; and

FIG. 10 is a drawing for explaining a hardware configuration of the part-of-speech determining apparatus according to the embodiment of the present invention.

### DETAILED DESCRIPTION OF THE INVENTION

Exemplary embodiments of an apparatus, a method, and a computer program according to the present invention will be explained in detail, with reference to the accompanying drawings.

To determine the parts-of-speech of words in Chinese, a part-of-speech determining apparatus according to an embodiment of the present invention makes use of the following characteristics (1), (2), and (3) that are related to Japanese, which is a language that uses KANJI (Chinese characters) that are similar to the characters used in Chinese:

(1) It is possible to bring some of the Chinese words that can be used both as a verb and as a noun into correspondence with “SA-hen” nouns in Japanese;

(2) It is easier to determine the parts-of-speech of the “SA-hen” nouns in Japanese than the parts-of-speech of the corresponding Chinese words; and

(3) The constructions of compound nouns (i.e., the word order) in Japanese and in Chinese have something in common.

More specifically, the part-of-speech determining apparatus according to the present embodiment mechanically constructs a database in advance, the database storing therein Japanese word sequences each of which has a meaning as a Japanese phrase and for each of which the parts-of-speech have been determined. When determining the part-of-speech of each of Chinese words that can be used both as a verb and as a noun, the part-of-speech determining apparatus refers to the information stored in the database. Normally, creating such a database requires that the data should be checked manually; however, as mentioned in (2) above, it is easier to determine parts-of-speech in Japanese than in Chinese. Thus, by collecting a large amount of texts and automatically separating the texts into words and assigning parts-of-speech to the words through a publicly-known morpheme analysis process, it is possible to create the database that makes it possible to determine the parts-of-speech with a high level of precision.

It is possible to apply the part-of-speech determining apparatus according to the present embodiment to a function for determining the part-of-speech for each of words that are obtained by analyzing Chinese sentences, the function being included in, for example, a term extracting apparatus that extracts terms from Chinese sentences that are input thereto, an analyzing apparatus that performs syntax analysis on Chinese sentences that are input thereto, or a machine-translation apparatus that translates Chinese sentences input thereto into another language. In the following sections, an example will be explained in which the part-of-speech determining apparatus is implemented as a term extracting apparatus that extracts terms out of Chinese sentences that are input thereto.

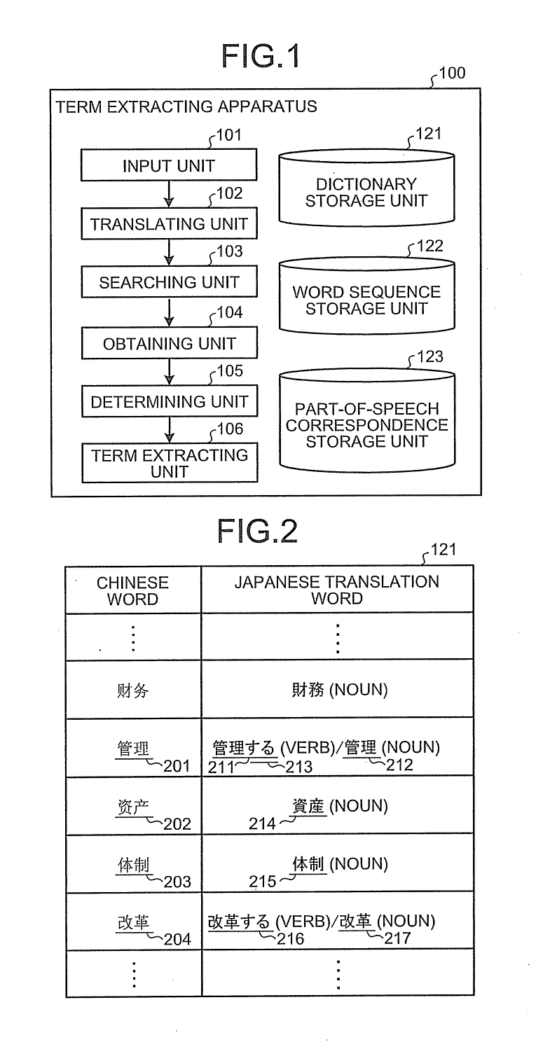

As shown in FIG. 1, a term extracting apparatus 100 includes: a dictionary storage unit 121; a word sequence storage unit 122; a part-of-speech correspondence storage unit 123; an input unit 101; a translating unit 102; a searching unit 103; an obtaining unit 104; a determining unit 105; and a term extracting unit 106.

The dictionary storage unit 121 stores therein a parallel translation dictionary in which Chinese characters are stored in correspondence with Japanese characters. As shown in FIG. 2, the parallel translation dictionary stores therein words in Chinese (i.e., Chinese words) and words in Japanese that are respectively in a parallel-translation relationship with the Chinese words (i.e., Japanese translation words), while keeping them in correspondence with one another.

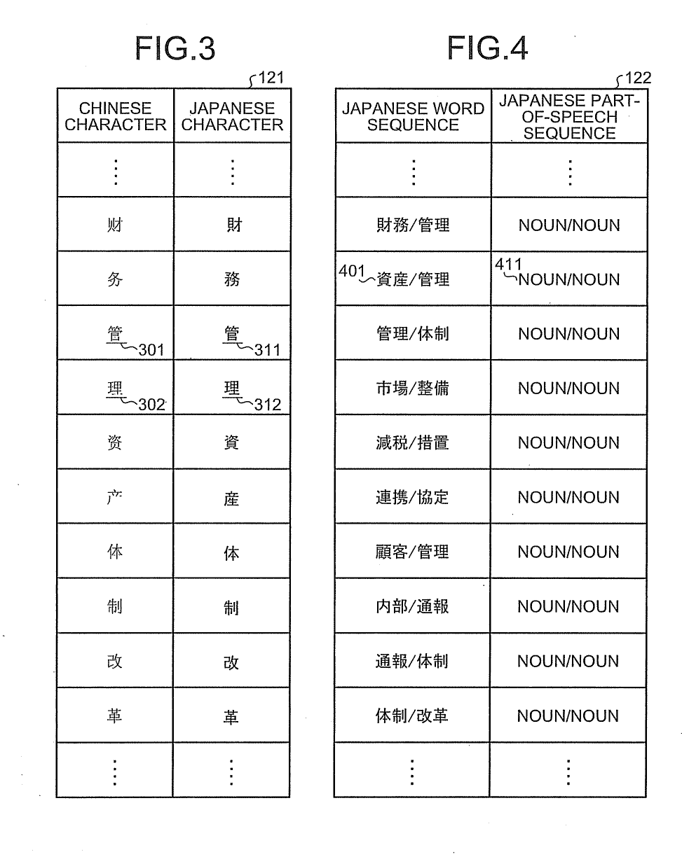

The data structure of the parallel translation dictionary is not limited to the example shown in FIG. 2. The parallel translation dictionary may be in any other format, as long as the dictionary can be used to convert Chinese into corresponding Japanese. Shown in FIG. 3 is another example of a parallel translation dictionary (hereinafter, the “Chinese-Japanese character correspondence table) in which single Chinese characters used in Chinese are kept in correspondence with corresponding Chinese characters used in Japanese, respectively.

Returning to the description of FIG. 1, the word sequence storage unit 122 stores therein (i) Japanese word sequences that are obtained in advance as phrases each of which is made up of a plurality of words that are used while being joined together and (ii) Japanese part-of-speech sequences each of which includes the Japanese parts-of-speech of the words contained in a corresponding one of the Japanese word sequences. The word sequence storage unit 122 is able to store therein Japanese word sequences each of which has an arbitrary length. However, according to the present embodiment, it is assumed that the word sequence storage unit 122 stores therein word sequences each of which is made up of two consecutive words.

To collect a large number of Japanese word sequences and their corresponding Japanese part-of-speech sequences as shown in FIG. 4, it is necessary to obtain a large amount of texts that are separated into words to which the parts-of-speech are respectively assigned (i.e., a corpus with part-of-speech tags). If the result of the process to separate the texts into words and the result of the process to assign the parts-of-speech to the words were to be checked manually, a large amount of labor would be required like in the conventional method. However, in Japanese, it is possible to obtain data that has a sufficiently high level of precision by using a publicly-known morpheme analysis technique, without manually checking the data.

For example, a Japanese translation word 212 in FIG. 2 is used as a noun and is often accompanied by a specific case particle. Alternatively, the Japanese translation word 212 may be used as a verb while being accompanied by a conjugation word ending that is in compliant with the context. For example, a Japanese translation word 211 in FIG. 2 is a verb obtained by adding a conjugation word ending 213 to the Japanese translation word 212. Because the Japanese language has definitive morphological characteristics as explained with these examples, it is possible to determine the parts-of-speech with a relatively high level of precision even when the determining process is mechanically performed by a computer.

On the other hand, a Chinese word 201 that is in correspondence with the Japanese translation word 212 can also be used both as a verb and as a noun. However, the Chinese language does not have equivalents of the conjugation word endings or the case particles that are used in Japanese. Thus, when a determining process is mechanically performed by a computer on the Chinese language, the level of precision of the result is lower than the result of the process performed on the Japanese language.

As mentioned in (2) above, the level of precision of the part-of-speech determining process performed on the Japanese “SA-hen” nouns is high. Thus, according to the present embodiment, the word sequence storage unit 122 stores therein the results of the part-of-speech determining process showing such word sequences that are each made up of only nouns. However, the parts-of-speech of the words contained in the stored Japanese word sequences are not limited to nouns. Another arrangement is acceptable in which the word sequence storage unit 122 stores therein Japanese word sequences each of which contains one or more words of which the part-of-speech is not a noun.

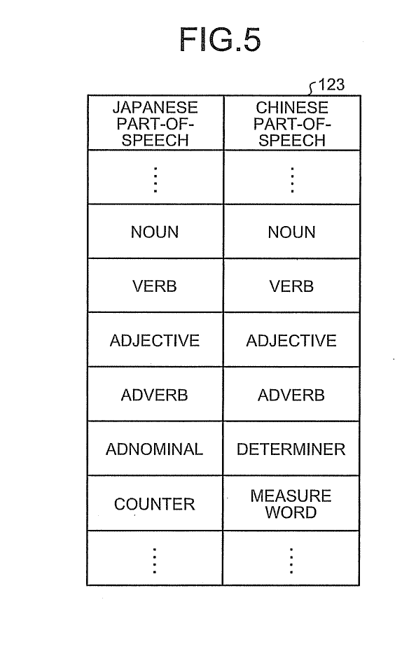

Returning to the description of FIG. 1, the part-of-speech correspondence storage unit 123 stores therein Japanese parts-of-speech and Chinese parts-of-speech, while keeping them in correspondence with one another. As shown in FIG. 5, the part-of-speech correspondence storage unit 123 stores therein parts-of-speech in Japanese (i.e., Japanese parts-of-speech) and parts-of-speech in Chinese (i.e., Chinese parts-of-speech) that respectively correspond to the Japanese parts-of-speech, while keeping them in correspondence with one another.

The dictionary storage unit 121, the word sequence storage unit 122, and the part-of-speech correspondence storage unit 123 may each be configured with any of commonly-used storage media of various types, such as Hard Disk Drives (HDDs), optical disks, memory cards, and Random Access Memories (RAMs).

Returning to the description of FIG. 1, the input unit 101 receives an input of a Chinese word sequence. The word sequence is input after being separated into words.

By referring to the dictionary storage unit 121 as shown in FIG. 2, the translating unit 102 conducts a search for corresponding Japanese translation words while using the input Chinese words as a key. In this manner, the translating unit 102 translates the input Chinese word sequence into Japanese so as to generate a translated word sequence, which is the result of the translation process. In the case where the Chinese-Japanese character correspondence table as shown in FIG. 3 is used, the translating unit 102 translates the input Chinese word sequence into Japanese by conducting a search for a corresponding Japanese character while using each of the characters included in the Chinese word sequence as a key.

For example, in the case where the Chinese word 201 shown in FIG. 2 is given as a key, the translating unit 102 obtains both the Japanese translation word 211 and the Japanese translation word 212, out of the dictionary storage unit 121 shown in FIG. 2.

In the case where the Chinese-Japanese character correspondence table as shown in FIG. 3 is used, when the Chinese word 201 shown in FIG. 2 is given as a key, the translating unit 102 first separates the Chinese word 201 into characters. As a result, the translating unit 102 has obtained a Chinese character 301 and a Chinese character 302 shown in FIG. 3. Subsequently, the translating unit 102 obtains a Japanese character 311 and a Japanese character 312 by conducting a search in the Chinese-Japanese character correspondence table while using each of the characters as a key. After that, as a Japanese translation word that corresponds to the Chinese word 201, the translating unit 102 obtains the Japanese translation word 212 shown in FIG. 2, which is a word obtained by joining together the Japanese character 311 and the Japanese character 312 that have been obtained.

Returning to the description of FIG. 1, the searching unit 103 conducts a search in the word sequence storage unit 122 for Japanese parts-of-speech that respectively corresponds to the words contained in the translated word sequence that has been obtained by the translating unit 102 as a translation of the input Chinese word sequence. More specifically, of the translated word sequence, the searching unit 103 sequentially selects a word sequence (i.e., a key word sequence) that is made up of two consecutive words to be used as a search key and conducts a search in the word sequence storage unit 122 for a Japanese part-of-speech sequence that is kept in correspondence with the Japanese word sequence that matches the selected key word sequence.

With regard to any of the Chinese words contained in the input Chinese word sequence, if the searching unit 103 has found, as a result of the search, the Japanese part-of-speech of the Japanese word obtained by translating the Chinese word, the obtaining unit 104 obtains the Chinese part-of-speech that corresponds to the Japanese part-of-speech found in the search, out of the part-of-speech correspondence storage unit 123.

The determining unit 105 determines the parts-of-speech of the words contained in the Chinese word sequence. More specifically, the determining unit 105 determines that the Chinese parts-of-speech obtained by the obtaining unit 104 are the parts of the speech of the corresponding Chinese words. The determining unit 105 outputs the determined parts-of-speech while keeping them in correspondence with the words contained in the input Chinese word sequence.

The term extracting unit 106 extracts terms from the input Chinese word sequence, while referring to the parts-of-speech determined by the determining unit 105.

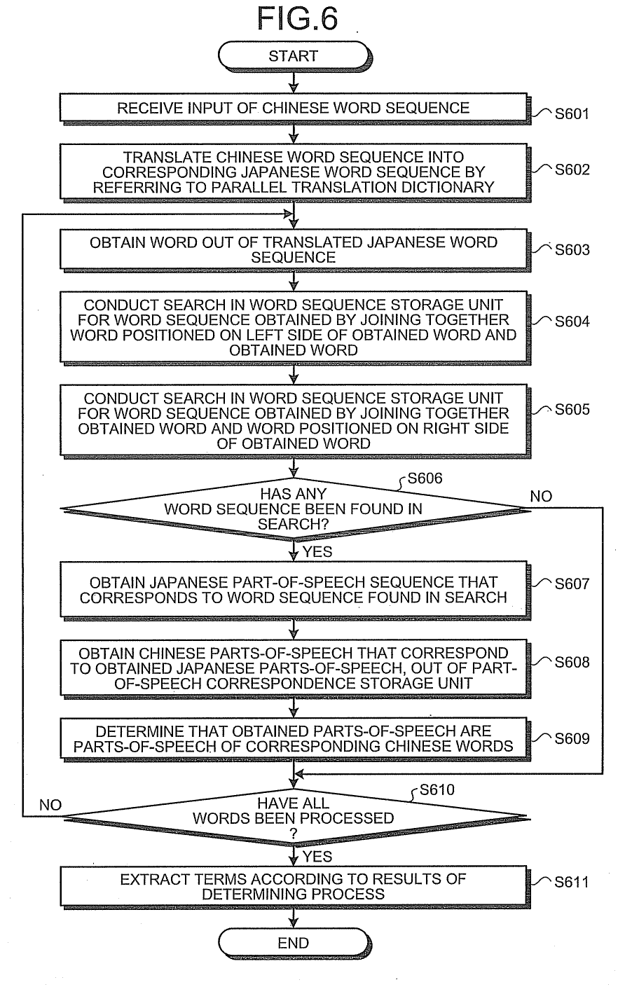

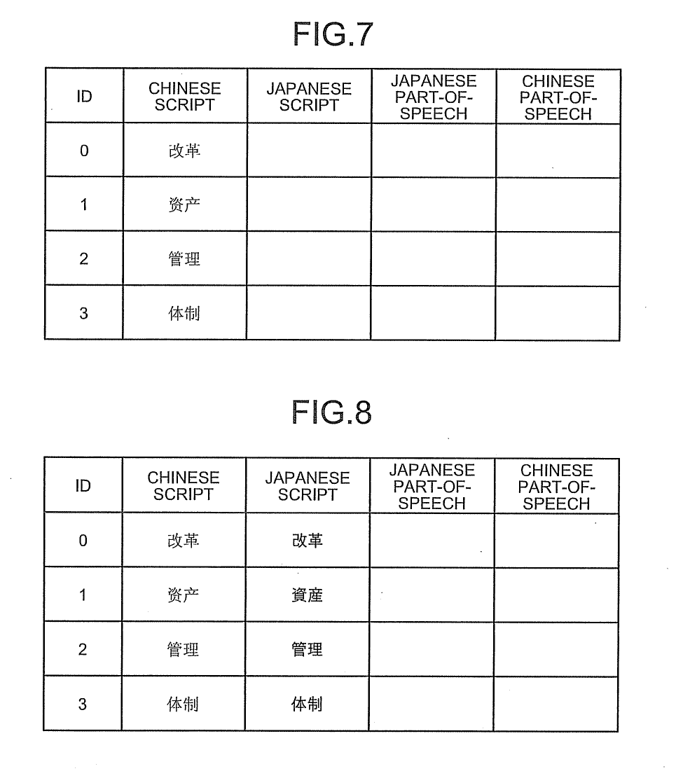

Next, a term extracting process performed by the term extracting apparatus 100 according to the present invention configured as described above will be explained, with reference to FIGS. 6 to 9. FIGS. 7, 8, and 9 are each a drawing of an example of a processing table that stores therein various types of data obtained in the term extracting process.

In the following sections, an example will be explained in which a Chinese word sequence that is made up of the four words shown in the “Chinese script” column in FIG. 7 has been input.

First, the input unit 101 receives an input of the Chinese word sequence that is made up of the four words (step S601). As shown in FIG. 7, the input unit 101 separates the input Chinese word sequence into words, assigns an ID to each of the words sequentially, according to the order in which the words are arranged, and arranges the words into the “Chinese script” column of the processing table.

After that, by referring to the parallel translation dictionary as shown in FIG. 2, the translating unit 102 translates the Chinese word sequence into corresponding Japanese words (step S602). More specifically, first, the translating unit 102 conducts a search in the “Chinese word” column of the parallel translation dictionary, while using the first Chinese word, which is the word identified with the ID “0” in FIG. 7, as a key. In the present example, because a Chinese word 204 matches the key, the translating unit 102 obtains the two corresponding Japanese translation words 216 and 217.

In the present embodiment, only nouns are determined as described above. Thus, the translating unit 102 adopts only the Japanese translation words that are nouns. Also, because the information related to the parts-of-speech is not necessary in the processes thereafter, the translating unit 102 obtains only the portions other than the information in the parentheses related to the parts-of-speech.

After that, the translating unit 102 conducts a search in the “Chinese word” column of the parallel translation dictionary, while using the next Chinese word, which is the word identified with the ID “1” in FIG. 7, as a key. In the present example, because a Chinese word 202 matches the key, the translating unit 102 obtains the corresponding Japanese translation word 214. In a similar manner, with respect to the Chinese word identified with the ID “2” in FIG. 7, the translating unit 102 obtains the Japanese translation word 212 that corresponds to the Chinese word 201 in FIG. 2. Also, with respect to the Chinese word identified with the ID “3” in FIG. 7, the translating unit 102 obtains a Japanese translation word 215 that corresponds to a Chinese word 203 in FIG. 2.

The obtained Japanese translation words are arranged into the “Japanese script” column of the processing table. Shown in FIG. 8 is the processing table obtained after the Japanese translation words have been arranged into the “Japanese script” column as described above. A word sequence obtained by arranging the Japanese translation words in the “Japanese script” column in ascending order of the ID numbers corresponds to a translated word sequence obtained by translating the input Chinese word sequence.

After that, the searching unit 103 sequentially obtains each of the words, starting with the first word in the translated word sequence (step S603). Subsequently, the searching unit 103 conducts a search in the word sequence storage unit 122, while using, as a key word sequence, a word sequence obtained by joining together the Japanese script of the word positioned on the left side of the obtained word and the Japanese script of the obtained word (step S604). It is assumed that the word sequence storage unit 122 stores therein data as shown in FIG. 4. As for the first word, because no word is positioned on the left side thereof, the searching unit 103 does not conduct a search in the word sequence storage unit 122 with respect to the first word.

Subsequently, the searching unit 103 conducts a search in the word sequence storage unit 122 while using, as a key word sequence, a word sequence obtained by joining together the Japanese script of the obtained word and the Japanese script of the word positioned on the right side of the obtained word (step S605). For example, the searching unit 103 uses a word sequence obtained by joining together the Japanese script identified with the ID “0” and the Japanese script that is positioned on the right side thereof and is identified with the ID “1” in FIG. 8, as a key word sequence. In the present example, the word sequence storage unit 122 shown in FIG. 4 has not registered therein the Japanese word sequence that matches the key word sequence. Thus, the searching unit 103 obtains no search result.

At steps S604 and S605, the word sequence obtained by joining together the word and the word positioned on the left side thereof or the word and the word positioned on the right side thereof is used as the key word sequence. However, to perform the process more efficiently, another arrangement is acceptable in which the part-of-speech determining process is performed by using, as the key word sequence, only the word sequence obtained by joining together the obtained word and the word positioned on the right side thereof.

After that, the searching unit 103 judges whether any Japanese word sequence that matches the key word sequence has been found in the word sequence storage unit 122, as a result of the search at step S604 or step S605 (step S606). In the case where no Japanese word sequence has been found in the search (step S606: No), the searching unit 103 judges whether all the words have been processed (step S610). In the case where all the words have not been processed yet (step S610: No), the searching unit 103 obtains the next word and repeats the process (step S603).

In the present example, the searching unit 103 is not able to obtain any search result for the first word. Thus, the process returns to step S603 so that the searching unit 103 obtains the next word. With respect to the second word, which is the word identified with the ID “1”, the searching unit 103 uses, as a key word sequence, the word sequence obtained by joining together the Japanese script identified with the ID “1” and the Japanese script that is positioned on the left side thereof and is identified with the ID “0”. In this situation, the word sequence storage unit 122 has not registered therein such a Japanese word sequence that matches the key word sequence, the searching unit 103 obtains no search result (step S604).

When the searching unit 103 uses, as a key word sequence, the word sequence obtained by joining together the Japanese script identified with the ID “1” and the Japanese script that is positioned on the right side thereof and is identified with the ID “2”, the searching unit 103 is able to find a Japanese word sequence 401 that matches the key word sequence in the word sequence storage unit 122 (step S605).

When a matching Japanese word sequence has been found in the search as in the present example (step S606: Yes), the searching unit 103 obtains a Japanese part-of-speech sequence that corresponds to the Japanese word sequence found in the search, out of the word sequence storage unit 122 (step S607). For example, in the case where the Japanese word sequence 401 has been found in the search, the searching unit 103 obtains a corresponding Japanese part-of-speech sequence 411 out of the word sequence storage unit 122 as shown in FIG. 4. The searching unit 103 then arranges the obtained part-of-speech sequence into the “Japanese part-of-speech” column of the processing table according to the order in which the words are arranged.

After that, the obtaining unit 104 obtains the Chinese parts-of-speech that respectively correspond to the obtained Japanese parts-of-speech, out of the part-of-speech correspondence storage unit 123 (step S608). For example, with respect to the Japanese part-of-speech “noun”, the obtaining unit 104 obtains the Chinese part-of-speech “noun”, out of the part-of-speech correspondence storage unit 123 as shown in FIG. 5. The obtaining unit 104 then arranges the obtained Chinese parts-of-speech into the “Chinese part-of-speech” column of the corresponding words.

After that, the determining unit 105 determines that the obtained Chinese parts-of-speech are the parts-of-speech of the Chinese words that have been translated into the Japanese words contained in the translated word sequence (step S609). For example, “noun” is arranged in the “Chinese part-of-speech” column of the word identified with the ID “1”. Thus, the determining unit 105 determines that the part-of-speech of the Chinese word identified with the ID “1” is a “noun”.

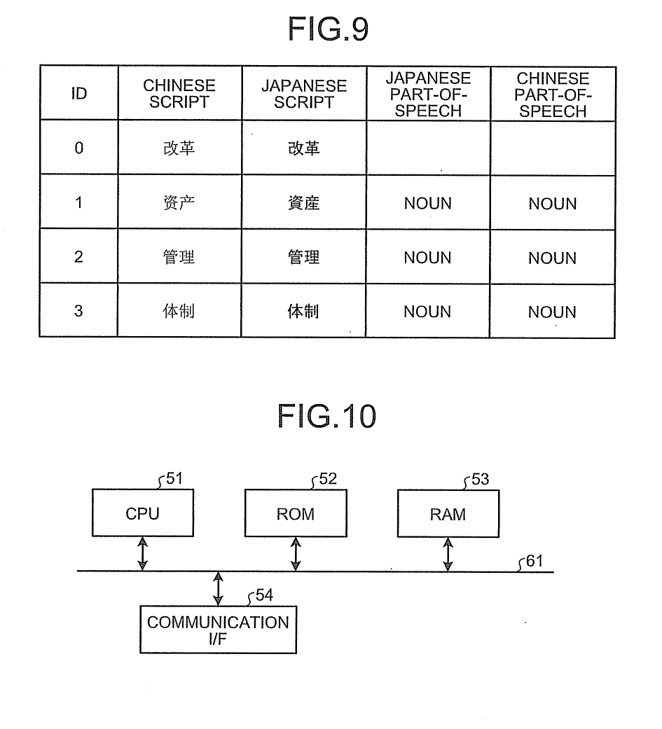

The same process is performed on the third word, which is the Chinese word identified with the ID “2”, and on the fourth word, which is the Chinese word identified with the ID “3”. Accordingly, the determining unit 105 obtains a result of the determining process showing that both of these words are nouns. The processing results that are eventually obtained are shown in the processing table in FIG. 9. In the present example, the results of the part-of-speech determining process show that the first Chinese word is not a noun, while each of the second to the fourth Chinese words is a noun.

Although omitted from the drawing, in the case where there are one or more words for which it is not possible to determine the part-of-speech by using the method described above, the parts-of-speech of such words are determined by employing a method that has conventionally been used.

When all the words have been processed, and it is judged at step S610 that all the words have been processed (step S610: Yes), the term extracting unit 106 performs the term extracting process on the input Chinese word sequence according to the results of the determining process (step S611). For example, in the case where the term extracting unit 106 extracts a set of consecutive nouns as a term, the term extracting unit 106 extracts a set of nouns obtained by joining together the Chinese scripts identified with the IDs “1”, “2”, and “3” shown in FIG. 9, as a term.

As explained above, the part-of-speech determining apparatus according to the present embodiment is configured so as to convert Chinese words into Japanese words and to determine the parts-of-speech of the Chinese words by referring to the information of the parts-of-speech of the Japanese word sequence. Generally speaking, to create such information of parts-of-speech for a word sequence, a corpus with part-of-speech tags is required. In Japanese, however, it is possible to construct such a corpus with part-of-speech tags having a high level of precision, by using a publicly-known morpheme analysis technique, without much human labor. Thus, it is possible to realize a part-of-speech determining apparatus that is able to determine the parts-of-speech in Chinese with a significantly smaller amount of labor than the labor required in the conventional method that uses a corpus with part-of-speech tags in Chinese.

Next, a hardware configuration of the part-of-speech determining apparatus according to the present embodiment will be explained, with reference to FIG. 10.

The part-of-speech determining apparatus according to the present embodiment includes: a controlling device such as a Central Processing Unit (CPU) 51; storage devices such as a Read Only Memory (ROM) 52 and a Random Access Memory (RAM) 53, a communication interface (I/F) 54 that establishes a connection to a network and performs communication; and a bus 61 that connects these constituent elements to one another.

A part-of-speech determining computer program (hereinafter, the “part-of-speech determining program”) that is executed by the part-of-speech determining apparatus according to the present embodiment is provided as being incorporated in the ROM 52 or the like.

Another arrangement is acceptable in which the part-of-speech determining program executed by the part-of-speech determining apparatus according to the present embodiment is provided as being recorded on a computer-readable recording medium such as a Compact Disk Read-Only Memory (CD-ROM), a flexible disk (FD), a Compact Disk Recordable (CD-R), a Digital Versatile Disk (DVD), or the like, in a file that is in an installable format or in an executable format.

Further, yet another arrangement is acceptable in which the part-of-speech determining program executed by the part-of-speech determining apparatus according to the present embodiment is stored in a computer connected to a network like the Internet, so that the part-of-speech determining program is provided as being downloaded via the network. Furthermore, yet another arrangement is acceptable in which the part-of-speech determining program executed by the part-of-speech determining apparatus according to the present embodiment is provided or distributed via a network like the Internet.

The part-of-speech determining program executed by the part-of-speech determining apparatus according to the present embodiment has a module configuration that includes the functional units described above (e.g., the input unit, the translating unit, the searching unit, the determining unit, and the term extracting unit). As the actual hardware configuration, these functional units are loaded into a main storage device when the CPU 51 reads and executes the part-of-speech determining program from the ROM 52, so that these functional units are generated in the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A part-of-speech determining apparatus that determines a part-of-speech of each Chinese word, the apparatus comprising:
a word sequence storage unit that correspondingly stores Japanese word sequences each of which is made up of a plurality of words used being joined together, and Japanese parts-of-speech of the words contained in the Japanese word sequences;
a part-of-speech correspondence storage unit that correspondingly stores Japanese parts-of-speech and Chinese parts-of-speech;
an input unit that receives an input of a Chinese word sequence;
a translating unit that translates the Chinese word sequence into a Japanese word sequence;
a searching unit that searches, while using consecutive Japanese words contained in the Japanese word sequence as a key word sequence, for Japanese parts-of-speech corresponding to one of the Japanese word sequences that matches the key word sequence from the word sequence storage unit;
an obtaining unit that obtains two or more of the Chinese parts-of-speech corresponding to the Japanese parts-of-speech searched by the searching unit, from the part-of-speech correspondence storage unit; and
a determining unit that determines that the obtained Chinese parts-of-speech are respectively parts-of-speech of Chinese words translated into the Japanese words contained in the key word sequence.

2. The apparatus according to claim 1, wherein the word sequence storage unit correspondingly stores the Japanese word sequences each of which is made up of the plurality of words whose parts-of-speech are nouns, and the Japanese parts-of-speech of the words contained in the Japanese word sequences.

3. The apparatus according to claim 1, wherein
the determining unit further brings the determined Chinese parts-of-speech into correspondence with words contained in the input Chinese word sequence, and
the apparatus further includes a term extracting unit that extracts a term from the Chinese word sequence that contains the words with which the Chinese parts-of-speech have been brought into correspondence.

4. The apparatus according to claim 1, wherein
the word sequence storage unit correspondingly stores the Japanese word sequences each of which is made up of a predetermined number of words, and the Japanese parts-of-speech of the words contained in the Japanese word sequences, and
the searching unit selects the key word sequence each of which is made up of the consecutive predetermined number of words contained in the Japanese word sequence, and conducts the search in the word sequence storage unit for the Japanese parts-of-speech corresponding to the one of the Japanese word sequences that matches the key word sequence.

5. The apparatus according to claim 4, wherein the searching unit selects the key word sequence each of which is made up of the consecutive predetermined number of words contained in the Japanese word sequence, conducts a first search in the word sequence storage unit for the one of the Japanese word sequences that matches the key word sequence, and conducts a second search in the word sequence storage unit for Japanese parts-of-speech that respectively correspond to the words contained in the one of the Japanese word sequences found in the first search.

6. The apparatus according to claim 1, further comprising a dictionary storage unit that correspondingly stores Chinese characters and Japanese characters, wherein
the translating unit translates the input Chinese word sequence into a Japanese word sequence by obtaining Japanese characters that respectively correspond to Chinese characters contained in the input Chinese word sequence, from the dictionary storage unit.

7. The apparatus according to claim 1, further comprising a dictionary storage unit that correspondingly stores Chinese words and Japanese words, wherein
the translating unit translates the input Chinese word sequence into a Japanese word sequence by obtaining Japanese words that respectively correspond to Chinese words contained in the input Chinese word sequence, from the dictionary storage unit.

8. The apparatus according to claim 1, wherein
the determining unit further brings the determined Chinese parts-of-speech into correspondence with words contained in the input Chinese word sequence, and
the apparatus further includes a analyzing unit that analyzes a syntax of the input Chinese word sequence using the Chinese parts-of-speech which have been brought into correspondence with words contained in the input Chinese word sequence.

9. A part-of-speech determining method implemented by a part-of-speech determining apparatus that determines a part-of-speech of each Chinese word, the method comprising:
receiving an input of a Chinese word sequence;
translating the Chinese word sequence into a Japanese word sequence;
conducting a search, while using consecutive Japanese words contained in the Japanese word sequence as a key word sequence, for Japanese parts-of-speech that correspond to one of Japanese word sequences that matches the key word sequence from word sequence storage unit correspondingly storing the Japanese word sequences each of which is made up of a plurality of words that are used while being joined together, and Japanese parts-of-speech of the words contained in the Japanese word sequences;
obtaining two or more of the Chinese parts-of-speech that correspond to the Japanese parts-of-speech searched by the searching unit, from a part-of-speech correspondence storage unit correspondingly storing Japanese parts-of-speech and Chinese parts-of-speech; and
determining that the obtained Chinese parts-of-speech are respectively parts-of-speech of Chinese words that have been translated into the Japanese words contained in the key word sequence.

10. A computer program product having a computer readable medium including programmed instructions for determining Chinese parts-of-speech, wherein the instructions, when executed by a computer, cause the computer to perform:
receiving an input of a Chinese word sequence;
translating the Chinese word sequence into a Japanese word sequence;
conducting a search, while using consecutive Japanese words contained in the Japanese word sequence as a key word sequence, for Japanese parts-of-speech that correspond to one of Japanese word sequences that matches the key word sequence from word sequence storage unit correspondingly storing the Japanese word sequences each of which is made up of a plurality of words that are used while being joined together, and Japanese parts-of-speech of the words contained in the Japanese word sequences;
obtaining two or more of the Chinese parts-of-speech that correspond to the Japanese parts-of-speech searched by the searching unit, from a part-of-speech correspondence storage unit correspondingly storing Japanese parts-of-speech and Chinese parts-of-speech; and
determining that the obtained Chinese parts-of-speech are respectively parts-of-speech of Chinese words that have been translated into the Japanese words contained in the key word sequence.
